(19) United States
(12) Patent Application Publication
(10) Pub. No.: US 2022/0295260 A1
(43) Pub. Date: Sep. 15, 2022

(54) TRIGGERING A TEMPORARY ROAMING AFTER AN OCCURRENCE OF AN EVENT

(71) Applicant: Telefonaktiebolaget LM Ericsson (publ), Stockholm (SE)

(72) Inventors: Badawi YAMINE, Beirut (LB); Tomas HEDBERG, Nacka (SE)

(73) Assignee: Telefonaktiebolaget LM Ericsson (publ), Stockholm (SE)

(21) Appl. No.: 17/636,101

(22) PCT Filed: Aug. 20, 2019
(86) PCT No.: PCT/SE2019/050762

§ 371 Date: Feb. 17, 2022

(51) Int. Cl. H04W 8/12; H04W 48/06

(52) U.S. Cl. CPC H04W 8/12; H04W 48/06; H04W 84/042

(57) ABSTRACT

Triggering a temporary roaming after an occurrence of an event. In one aspect there is a method for triggering a temporary roaming, which the method includes a first node obtaining information indicating an occurrence of an event. The method further includes after obtaining the information, the first node (i) initiating a broadcast of a warning message providing a notification of the occurrence of the event and (ii) sending toward a second node belonging to a second PLMN a roaming activation request for requesting an activation of a roaming service. The method further includes after sending the roaming activation request, the first node receiving an acknowledgement message authorizing the roaming service and as a result of receiving the acknowledgement message authenticating the roaming service, the first node initiating a broadcast of an alarm message.

### TECHNICAL FIELD

Disclosed are embodiments related to triggering a temporary roaming after an occurrence of an event.

### BACKGROUND

When a natural disaster occurs in an area, according to 3GPP (The 3rd Generation Partnership Project) standards (in particular specification 36.331 for 4G and 38.331 for 5G), a Radio Node (RN) (e.g., a 5G base station) broadcasts an alert for providing notice of the occurrence of the natural disaster in the area (e.g., activating a Public Warning System (PWS) such as Commercial Mobile Alert Service (CMAS) and Earthquake and Tsunami Warning System (ETWS)).

Upon broadcasting the notification, it may be desirable to activate a temporary roaming for user equipments (UEs) in the area in which the natural disaster has occurred. For example, when there is an earthquake in an area served by two base stations operated by two mobile network operators (MNOs), the base station operated by a first MNO might be congested due to sudden increase of network usage while the base station operated by a second MNO might not be congested due to a low number of UEs served by the second MNO. In such case, there may be a benefit of the second MNO activating a temporary roaming such that the UEs served by the first MNO in the area can use the network of the second MNO for at least a temporary duration.

In activating a temporary roaming, the following factors may be considered.

1. Activating a roaming at a good point in time with short interruption—When there is a disaster in an area and networks serving the area are overloaded, the UEs located within the area should not switch their networks frequently because frequent switching of the networks increases network load and may cause end-user disturbances. Some switchings of the networks, however, may be needed for load balancing across the networks even when some networks are excessively loaded. For example, when only some cells are overloaded, it may be beneficial to allow network switching to achieve load balancing between the congested cells and uncongested cells. On the other hand, when all cells within the area are overloaded, the network switching should be stopped in order to prevent UEs from continuing to attempt to access a new network when they are better to stay with the current network and to get at least some service from the current network (even if getting the service might require a long wait).

2. Authority's Mandate of Roaming Activation in Defined Conditions—Unless there is a requirement for MNOs to activate a roaming service, there may be no business incentive for the MNOs to active the roaming service. Therefore, it may be desirable to mandate a roaming activation under some circumstances. In case MNOs are required to activate a roaming service, a message triggering the MNOs to activate the roaming service may be received through Cell Broadcast Center—Cell Broadcast Entity (CBC-CBE) interface.

3. Lack of Mandate of Full Gateway Core Network (GWCN) Interconnect—It is unlikely that authorities will mandate full GWCN interconnect. In that case, at least establishment of the S10 interface (of the 3GPP standards) is needed for MNOs. The S10 interface establishment would enable a handover and a cell reselection between Public Land Mobile Networks (PLMNs), and all networks would essentially behave as one. This option is not a roaming but a regular mobility is applied between different networks. But due to issues related to complexity and leakage of MNO-specific info, a roaming may be a preferred choice over this option (at least in pre-5G. In 5G, a new way of using N2IWF tunnels may be devised.)

4. Minimizing PLMN changes—Switching to a roaming service may cause interruptions on active end-user services. Thus, it is desirable to minimize the PLMN changes. The PLMN changes may be reduced by allowing a roaming only in an idle mode—ideally if no data bearer is established. If it is possible to determine at a Registered Public Land Mobile Network (RPLMN) side as to whether a UE is “essentially idle,” then a new form of “Release with Redirect” can be used to direct individual UEs to other specific PLMNs.

5. Long Roaming Interruption and Requiring Manual Start—Existing roaming interruption may be long or may even require manual restart (of applications). To prevent these, it may be needed to inform UEs about suitable PLMN IDs and at least one E-UTRA Absolute Radio Frequency Channel Number (EARFCN) per a PLMN and/or to adapt 23.122 priority rules of the 3GPP standards in order to reduce the duration of searching for PLMNs.

6. New logic to tell UEs when new roaming rules apply—An indicator (e.g., included in a broadcasted message) or at least a new interpretation of presence of a PWS alarm is needed. If RPLMN cells die prior to sending an indication of “alarm situation,” then UEs served by the RPLMN cells may rely on a broadcasted message from cells belonging to partner PLMNs.

### SUMMARY

Existing methods of triggering a roaming may have the following two problems.

Problem 1—No verification of the occurrence of an event within an area before activating a roaming within the area

Operators are usually reluctant to allow roaming among each other when they cover the same geographical areas for various reasons.

First, there is an economic reason. Each operator builds a network for its own subscribers and invests money to improve quality and capacity of its network. For example, a first operator might have spent more than twice the money on building and improving its network in a particular region as compared to the amount that a second operator has spent for its network in the region. Thus, activating a roaming only when it is certainly required would be fair to the operator which has spent more money on its network in the region.

Second, activating a roaming in a network requires additional technical works such as configuring different network nodes (e.g., RN, charging nodes, core nodes, Home Subscriber Server (HSS)) and their interfaces.

Third, activating a roaming requires a commercial agreement between MNOs (as to e.g., how much the MNOs would charge per minute for the roaming service).

Accordingly, it may be desirable for the MNOs to active a roaming only when an occurrence of an event that triggers the roaming is verified among the MNOs. Such verification is needed to prevent “unfair” or “fake” roaming activation.

The following scenarios describe how “unfair” or “fake” roaming activation might arise.

Scenario 1.1—A first MNO has activated ETWS on all of its RNs in an area at 9:00 am while a second MNO has activated ETWS on all of its RNs in the area at 12:00 pm (in case authorities have not deployed a complete PWS, but require MNOs to provide a disaster detection function). In this case, it is not fair for the second MNO to activate a roaming before 12:00 μm.

Scenario 1.2—The first MNO has activated by mistake ETWS on its RNs in an area where there is no disaster (e.g., earthquake, fire). The mistake may be caused by a human mistake (e.g., an engineer of the first MNO accidently activated the ETWS on the RNs of the first MNO), a software bug, or via a malicious software. In this case, it is not fair for the second MNO to activate a roaming.

Problem 2—Lack of coordination mechanisms for roaming when an event (e.g., earthquake, fire) occurs in an area

Scenario 2.1—All network nodes of an operator that serve within an area experience an outage.

Wireless nodes as electronic equipments are subject to hardware or software faults that may put them into outage. In addition, even when there is no hardware or software issue in the nodes, the nodes might experience an outage due to external issues (e.g., a transmission issue or core network equipment issues). For example, suppose that one particular geographical area (area 1) is served by two operators (operator 1 and operator 2) and that during a natural disaster, all wireless equipments of the operator 1 go down (e.g., due to a transmission failure resulting from that active and passive microwave links went down) whereas wireless equipments of the operator 2 remain functioning in the area 1. Because subscribers of the operator 1 cannot make calls on the equipments of the operator 2 (without any roaming service), all subscribers of the operator 1 will not be able to make any non-emergency call in the area 1 even though the equipments of the operator 2 are not affected by any outage. In other words, even though the subscribers of the operator 1 can still make an emergency call (e.g., calling 112 in Europe or 911 in the United States), they won't be able to make any non-emergency calls (e.g., calling their relatives or receiving calls from their relatives).

Scenario 2.2—At least one network node of an operator serving within an area experiences an outage or is congested.

Suppose that network nodes of the operator 1 and network nodes of the operator 2 serve an area and that an event (e.g., earthquake, fire) has occurred in the area. Even if some network nodes of the operator 1 may become congested due to sudden increase of network traffic caused by the occurrence of the event, the self-organizing network (SON) features of the network can handle the congestion issue of the operator 1 by redirecting the antennas of uncongested neighboring network nodes toward the area 1. Thus, in this case, no roaming activation is needed.

If, however, one or more network nodes of the operator 1 covering the area experiences an outage at the time of the occurrence of the event, the SON features of the operator 1 might not be enough to cover the coverage hole caused the network node(s) that went into outage. As a result, some subscribers of the operator 1 can only make emergency calls (e.g., calling 112 in Europe or 911 in the U.S.) on network node(s) of the operator 2 but cannot make any non-emergency calls (e.g., video calls) on any network node of the operator 2.

In a summary, there are two potential reasons why the subscribers of the operator 1 might not be able to make non-emergency calls in their own network (the network of the operator 1).

The first reason is network outage of the operator 1 in the event affected area during the event occurrence period.

The second reason is network congestion of the operator 1 in the event affected area during the event occurrence period. At the time of the occurrence of the event, the number of subscribers of the operator 1 present in the event affected area might be much greater than the number of subscribers of the operator 2 present in the event affected area, and the network equipments of the operator 1 might not be prepared for such high number of subscribers.

Scenario 2.3—None of network nodes of an operator that serve within an area experiences an outage or becomes congested.

If the network equipments of the operator 1 are not affected by any outage at the time of the occurrence of the event and if the number of subscribers located within the event affected area is low at time of the occurrence of the event, there is no need to activate a roaming. For example, suppose that there are cell 1 of the operator 1 and cell 2 of the operator 2 serving in a particular area. The cell 1 is configured to support a maximum of 1000 users simultaneously and the cell 2 is configured to support a maximum of 700 users simultaneously. Also suppose that an event has occurred in the particular area at night time and at the time of the occurrence of the event, there were 300 cell 1 users and 400 cell2 users. In this example, even after the event has occurred within the area, all users of the operator 1 located in the area can be handled by the operator 1 and all users of the operator 2 located in the area can be handled by the operator 2. As a result, there is no reason to trigger any roaming in the area.

Some embodiments are provided to solve the aforementioned problems.

According to a first embodiment, a roaming activation is not performed without an agreement from both operators about the “authenticity” of an event (e.g., earthquake, flood, fire). For example, if a first operator detects an occurrence of an event, it may report the occurrence of the event to a second operator while asking for a temporary roaming activation. This reporting may be a message interchange on the S6a interface (of the 3GPP standard) between the operators or a new inter-network operation and maintenance (OAM) interface. Upon receiving the request, the second operator (i.e., the target operator) may accept or reject the roaming activation request. In some embodiments, a joint CBC interface of the first operator and the second operator may be used to interface an authority CBE. In such case, the first and second operators receive information about the occurrence of an event through the joint CBC interface.

According to a second embodiment, even if an emergency situation has occurred and both operators agree on roaming, a UE of the first operator may not try to switch to the second operator unless particular conditions (e.g., cells of the first operator are congested in the area where the emergency situation has occurred) of the first operator have been verified.

According to a third embodiment, even if an emergency situation has occurred in an area and a UE of the first operator located in the area is eligible for roaming to the second operator, the roaming may not allowed unless at least one cell of the second operator covering the area where the emergency situation has occurred is not congested. Otherwise the roaming may be rejected.

According to a fourth embodiment, if an emergency situation has occurred in an area and one or more network nodes of the first operator covering the area experiences an outage, then even if all network nodes of the second operator are congested, any UE of the first operator located in the area may roam and make calls using the network of the second operator.

According to a fifth embodiment, when a UE of the first operator is permitted to switch from the first operator to the second operator, in order to speed up the switching process, network nodes of the first operator serving the area may broadcast the following two types of information:

First type (info1): An indication about an emergency situation (e.g., an alarm state indicator).

Second type (info2): A “Pseudo-EPLMN info” that means:
Which PLMNs are to be considered “High Prio” in 23.122 ranking (e.g., EPLMN-like; NAS info) of the 3GPP standard. “High Prio” means that the UE scanning for the highest prio PLMN can stop scanning as soon as one of these PLMNs are found and does not continue to search for RPLMN/HPLMN/EHPLMN. This modifies current 23.122 clause 4.4.3.2.1 by extending the NOTE 1 of clause 4.4.3.1 to a new category of PLMNs (when ‘alarm state’ is active).
Which few EARFCNs to search with priority to find the above PLMNs (radio info, found in e.g. SIB5).

According to a sixth embodiment, when the emergency situation is ceased, network nodes of the both operators may stop broadcasting information mentioned in the fifth embodiment and the roaming will be ceased.

According to a seventh embodiment, if the signaling path to a network node (e.g., a serving evolved NodeB (eNB)) failed before any input mentioned in the fifth embodiment was conveyed to the UE, then the eNB may stop transmission after a time-out (typical behavior of legacy designs) or send a new indication “not operational” to prevent UEs from wasting time trying to connect to the eNB. The UEs associated with this failed eNB may initially perform cell reselection among the cells in a neighbor cell list that is provided via broadcast and that has dedicated priorities.

If the UEs don't find any cell in the area where the emergency situation has occurred within a period, the UEs may start searching all frequencies and RATs that the UEs are capable of handling (legacy 3GPP-compliant UE behavior). During the search, the UEs may prioritize the EARFCNs and PLMNs of the fifth embodiment and the UEs may detect, based on the broadcast of the listed potential target cells (i.e., co-operating networks), that an emergency situation is active, as described in fourth embodiment, and thus the indication about an emergency situation (e.g. “alarm state” indicator) is considered active to the UE.

This indicates to the UEs that the “pseudo-EPLMNs” information is active and selection of cells shall be done accordingly. Only the information sent by co-operating networks may be used by the UEs to classify the state to minimizes the risk of activation of “alarm state” when roaming hasn't been activated between the co-operating networks.

The fifth, sixth and seventh embodiments may be considered as Radio Access procedures.

The information mentioned in the fifth embodiment may be conveyed from the home network to the UEs via a radio resource control (RRC) protocol (fifth & sixth embodiment) or may not be conveyed (in the seventh embodiment).

According to an eight embodiment, the information mentioned in the embodiment may be conveyed via a core network (in particular via non-access stratum (NAS) protocol messages).

Option 1: via USIM information—The USIM may be remotely updated using one of more of several methods including legacy GSM 03.48 and associated protocols and more recent GSMA eSIM protocols. The new “pseudo-EPLMN” info can be an update of 3GPP Technical Specification (TS) 31.102 EFEHPLMN. The few EARFCNs to search with priority can be included in an update of 31.102 EFNETPAR. New fields or even a complete USIM sub-entity may be used for disaster state.

Option 2: via NAS information—Applies primarily to the new “pseudo-EPLMN” info (see info2 above). This can be implemented as a particular PLMN category stored within the existing EPLMN list (see e.g. 24.301 clause 5.3.4), where the new category is used in disaster state. For option 2 the updates of the list(s) is done at Attach and/or Location Update signaling.

According to some embodiments of this disclosure, in one aspect there is a method performed for triggering a temporary roaming. The method comprises a first node obtaining information indicating an occurrence of an event. The first node may belong to a first public land mobile network. The method further comprises after obtaining the information, the first node (i) initiating a broadcast of a warning message providing a notification of the occurrence of the event and (ii) sending toward a second node belonging to a second PLMN a roaming activation request for requesting an activation of a roaming service. The second PLMN may be different from the first PLMN. The method further comprises after sending the roaming activation request, the first node receiving an acknowledgement message authorizing the roaming service. The acknowledgement message may be sent by the second node. The method further comprises as a result of receiving the acknowledgement message authenticating the roaming service, the first node initiating a broadcast of an alarm message. The alarm message may indicate the authorization of the roaming service.

In other aspect there is a method performed by a user equipment (UE). In some embodiments, the method comprises receiving a warning message providing a notification of an occurrence of an event. The warning message may be broadcasted by a first network node belonging to a first public land mobile network. The method further comprises receiving an alarm message. The alarm message may indicate that the UE is authorized to connect to a node belonging to a PLMN that is different from the first PLMN provided that a roaming condition is satisfied. The method further comprises determining whether the roaming condition is satisfied and after receiving the alarm message and after determining that the roaming condition is satisfied, sending an access request toward a second network node belonging to a second PLMN that is different from the first PLMN.

In other aspect there is a method for triggering a temporary roaming. In some embodiments, the method comprises a first node receiving a roaming activation request for requesting an activation of a roaming service. The roaming activation request may be sent by a second node and the roaming activation request may include information indicating an occurrence of an event. The method further comprises after receiving the roaming activation request, the first node checking the validity of the information indicating the occurrence of the event and as a result of determining that the information indicating the occurrence of the event is valid, the first node sending toward the second node an acknowledgement message authorizing the roaming service. The first node may belong to a first public land mobile network (PLMN), and the second node may belong to a second PLMN that is different from the first PLMN.

In other aspect there is a method performed by a user equipment (UE). In some embodiments, the method comprises determining that the UE is unable to connect to a first public land mobile network (PLMN). The first PLMN may be the UE's home PLMN. The method further comprises receiving a warning message providing a notification of an occurrence of an event. The warning message may be broadcasted by a second PLMN that is different from the first PLMN. The method further comprises as a result of determining (i) that the UE is unable to connect to the first PLMN and (ii) that the UE has received the warning message providing the notification of the occurrence of the event, sending an access request for accessing the second PLMN.

### BRIEF DESCRIPTION OF THE DRAWINGS

The accompanying drawings, which are incorporated herein and form part of the specification, illustrate various embodiments.

FIG. 1 shows a portion of a communication system according to some embodiments.

FIG. 2 is a flow chart illustrating a method of triggering a roaming activation according to some embodiments.

FIG. 3 illustrates an exemplary roaming interface according to some embodiments.

FIG. 4 illustrates a service architecture according to some embodiments.

FIG. 5 is a flow chart illustrating a method of triggering a roaming activation according to some embodiments.

FIG. 6 is a flow chart illustrating a method of triggering a roaming activation according to some embodiments.

FIG. 7 is a flow chart illustrating a method of triggering a roaming activation according to some embodiments.

FIG. 8 is a flow chart illustrating a method of terminating a roaming activation according to some embodiments.

FIG. 9 is a flow chart illustrating a process according to some embodiments.

FIG. 10 is a flow chart illustrating a process according to some embodiments.

FIG. 11 is a flow chart illustrating a process according to some embodiments.

FIG. 12 is a block diagram illustrating an apparatus according to some embodiments.

FIG. 13 is a block diagram illustrating an apparatus according to some embodiments.

FIG. 14 is a block diagram illustrating an apparatus according to some embodiments.

FIG. 15 illustrates an interface according to some embodiments.

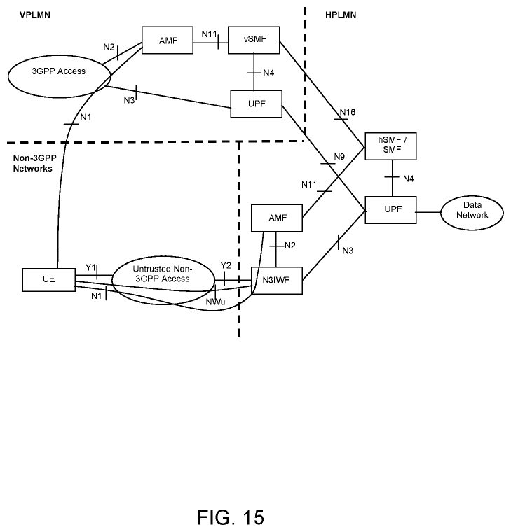

### DETAILED DESCRIPTION

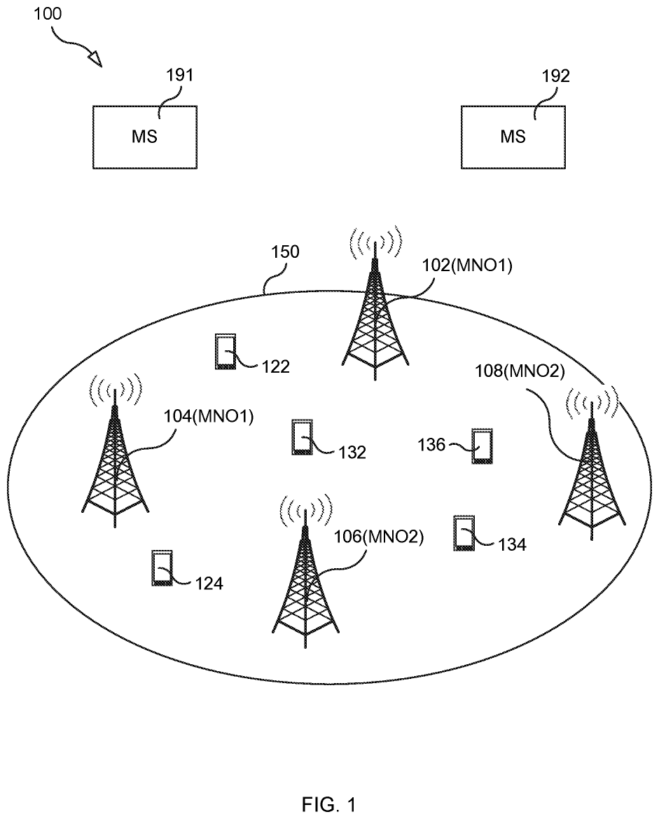

FIG. 1 shows a portion of an exemplary communication system 100 according to some embodiments.

In an area 150, there are two network nodes 102 and 104 that belong to a first Mobile Network Operator (“MNO”). The network nodes 102 and 104 serve user equipments (UEs) 122 and 124 of the first MNO (“MNO1”) within the area 150, and may be in communication with a management system 191 (“MS”) of the MNO1. Also, in the area 150, there are two network nodes 106 and 108 that belong to a second MNO (“MNO2”). The network nodes 106 and 108 serve UEs 132, 134, and 136 of the second MNO within the area 150, and may be in communication with a MS 192 of the MNO2. Each of the network nodes may be a base station (e.g., eNB). In some embodiments, a MS is an operating support system (“OSS”) of a MNO.

Due to the occurrence of an event (e.g., earthquake, fire) in the area 150, the UEs 122 and 124 served by the network nodes 102 and/or 104 may not be able connect to the network node(s) or may be able to connect to the network node(s) but the network node(s) may be congested. In this scenario, it may be desirable to activate a temporary roaming at the network nodes 106 and/or 108 to serve the UEs 122 and 124.

The number of network nodes and the number of UEs shown in FIG. 1 are just provided for illustration purpose only and do not limit the embodiments of this disclosure in any way.

According to some embodiments of this disclosure, a method of activating a temporary roaming is provided. The method comprises activating a temporary roaming after MNOs agree that there is a need to activate the roaming.

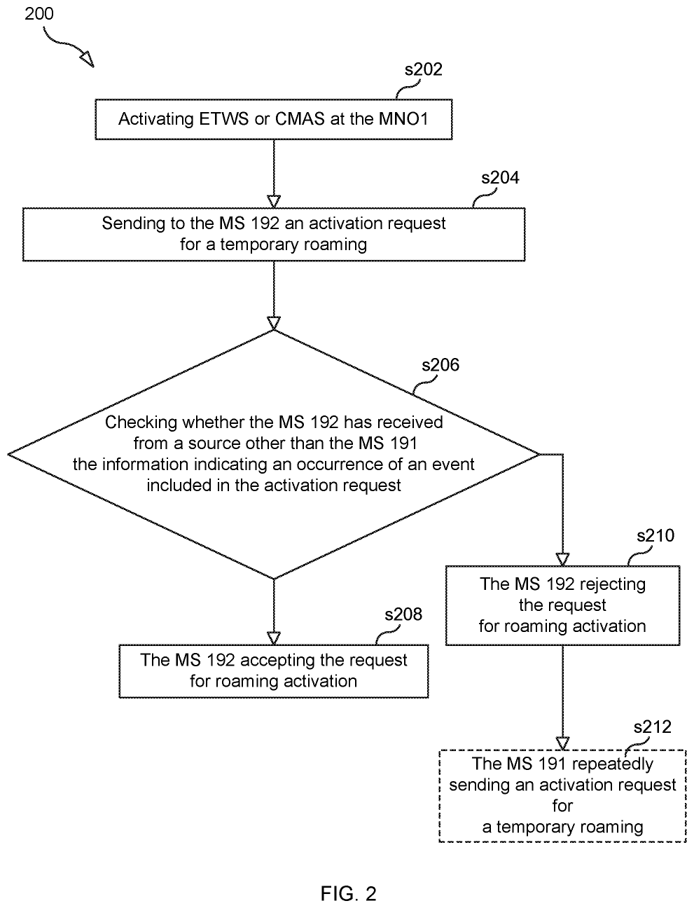

FIG. 2 is a flow chart illustrating a method 200 of activating a temporary roaming according to some embodiments. The method 200 may begin with step s202. The step s202 comprises activating ETWS or CMAS at the MNO1 (e.g., informing the network nodes 102 and 104 of the MNO1 messages indicating an occurrence of an event). Note that the embodiments of this disclosure are not limited to the ETWS or the CMAS, which are provided just for illustration purpose only. Any warning system indicating an occurrence of an event may be used instead of the ETWS or the CMAS.

After activating the ETWS or CMAS at the MNO1, in step s204, the MS 191 sends to the MS 192 a request for a roaming activation. The request may include information indicating the occurrence of the event in the area affected by the event.

After the MS2 receives the request for a roaming activation, in step s206, the MS2 checks whether the MS2 has obtained the information indicating the occurrence of the event in the area from a source other than the MS 191.

If the MS 192 has received the information, then in step s208, the MS 192 accepts the request for roaming activation and sends to the MS 191 an acknowledgement message indicating that the request has been accepted.

In some embodiments, the roaming activation resulting from the step s208 only allows the UEs 122 and 124 belonging the MNO1 (e.g., the subscribers of the operator which has requested for roaming) to access the network nodes 106 and/or 108 of the MNO2 (i.e., a single directional roaming activation). In other embodiments, the roaming activation not only allows the UEs 122 and 124 belong to the MNO1 to access the network nodes 106 and/or 108 but also allows the UEs 132, 134, and 136 belonging to the MNO2 to access the network nodes 102 and/or 104 of the MNO1 (i.e., a bi-directional roaming activation).

If the MS 192 has not received the information indicating the occurrence of the event in the area, in step s210, the MS 192 rejects the request for roaming activation and sends to the MS 191 a message indicating that the request has been rejected. The MS 192's failure to receive the information may be the result of a false activation of the ETWS or the CMAS at the MNO1 or may be the result of a time delay between the activation timing of the ETWS or the CMAS at the MNO1 and the activation timing of the ETWS or the CMAS at the MNO2. For example, if the ETWS was activated at the MNO1 at 9:00 am while the ETWS was activated at the MNO2 at 12:00 μm, the request for activation sent by the MS 191 between 9:00 am and 12:00 pm would be rejected by the MS 192 because the MS 192 would not have received the information before 12:00 μm.

According to some embodiments, the roaming activation request in the step s204 and the roaming activation responses in the steps s208 and s210 may be added to the roaming interface S6a (or other roaming interfaces such as S8, S9, Ici, and Izi of the 3GPP standards). In other embodiments, the roaming activation request/response may be carried through Operation and Maintenance (OAM) interfaces between the MNO1 and the MNO2.

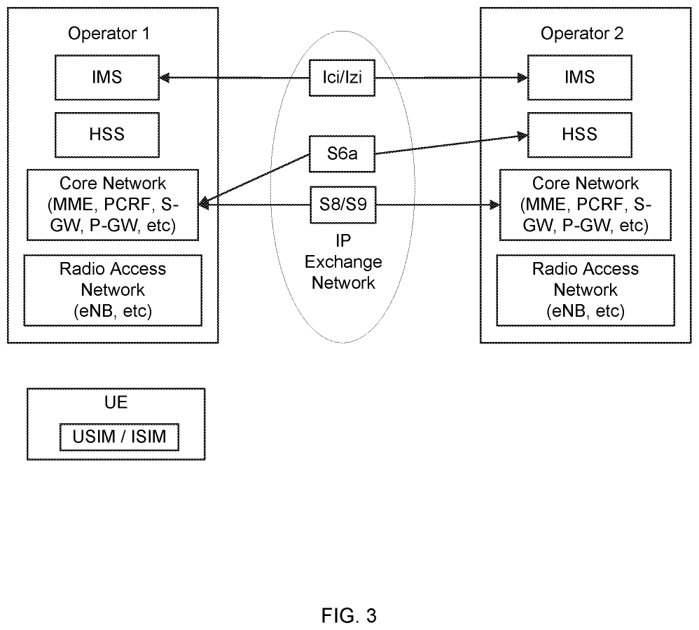

FIG. 3 shows an exemplary roaming interface according to some embodiments. The roaming interface may be Evolved Terrestrial Radio Access Network (EUTRAN) interface.

Establishing a roaming in the network of the MNO2 for the UEs 122 and 124 belonging to the MNO 1 may require:

UE authentication (e.g., verification of an identity which is essential for several other functions);

Home routing of traffic across the S8 interface (if required by the MNO 2);

Setting appropriate Quality of Service (QoS) per service via the S9 interface (if required); and

IP multimedia subsystem (IMS) interfaces to enable IMS services. The serving Proxy—Call Session Control Function (P-CSCF) may be located in the home network and the Izi interface may be needed.

More details regarding the roaming interface may be found, for example, in GSMA IR.65, GSMA IR.88, and 3GPP 23.228. For the “limited service state,” serving only Emergency Calls and PWS, none of the above interfaces may be needed. One example for IMS Emergency call support is specified in 3GPP 23.167.

Referring back to FIG. 2, after the MS 191 receives from the MS 192 a message rejecting the roaming activation request, in optional step S212, the MS 191 may repeatedly send to the MS 192 the activation request until the request is accepted by the MS 192. The repeated transmission of the request may be periodic for a predefined period or it may be based on an occurrence of a particular event (e.g., when the MS 192 receives updated information regarding the occurrence of an event in the area).

The CMAS or the ETWS may be activated at the MNO1 and/or at the MNO2 based on event occurrence information that the MNO1 and the MNO2 receive using separate CBC-CBE interfaces or a joint CBC interface interfacing an authority CBE.

In case a joint CBC interface is used, the MNO1 and the MNO2 may receive CBE-CBC messages containing a reference code indicating an occurrence of an event in an area. Thus, when the joint CBC interface is adopted, the activation request sent by the MS 191 to the MS 192 in step s204 may include the reference code the MNO1 obtained via the joint CBC interface and, in step s206, the MS 192 may compare the reference code the MNO2 obtained using the joint CBC interface with the reference code included in the activation request received from the MS 191.

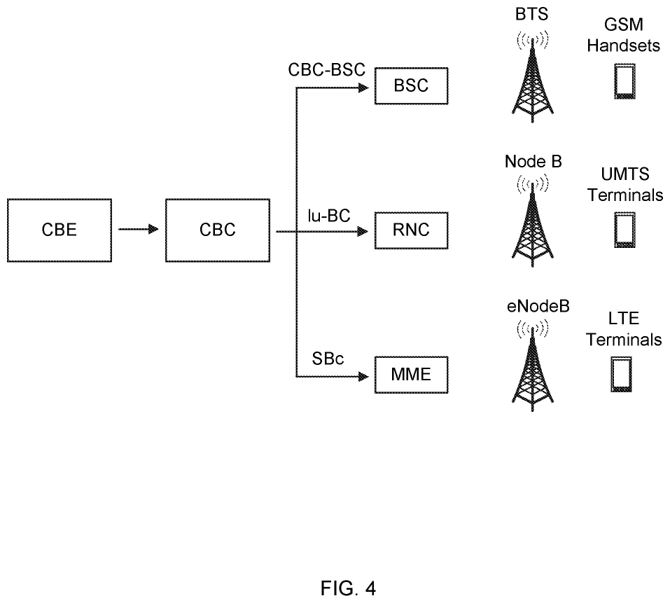

FIG. 4 shows a basic “Cell Broadcast Service” architecture adopting a joint CBC interface according to some embodiments.

When the architecture shown in FIG. 4 is implemented, a natural trigger of requesting inter-PLMN activation of a temporary roaming is the reception of the Public Warning messages issued by the relevant authority over the CBE-CBC interface. See GSMA “Mobile Network Public Warning Systems and the Rise of Cell-Broadcast” for references (incorporated by reference in this disclosure).

The warning messages issued by the relevant authority may include areas affected by an event and starting/ending times of the event.

In some geographical areas, there may not be any Public Warning System deployed among MNOs. In other words, authorities may have delegated the responsibility of detecting an occurrence of an event to individual operators. Accordingly, in some embodiments, the MNOs may agree to activate a roaming when at least one of the MNOs detects an occurrence of an event in an area.

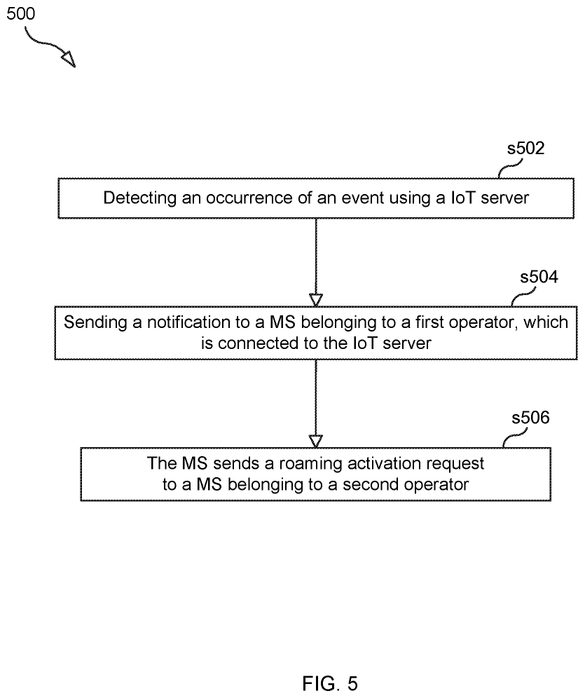

FIG. 5 is a flow chart illustrating a method 500 of activating a temporary roaming according to such embodiments.

The method 500 may begin with step s502. In the step s502, an internet-of-thing (“IoT”) server detects an occurrence of an event (e.g., earthquake, fire) in an area. The occurrence of the event may be detected using sensors or by monitoring the frequency of emergency calls corresponding to the area. After detecting the occurrence of the event, in step s504, the IoT server sends to a MS of a first operator, which is connected to the IoT server, a notification indicating the occurrence of the event. Upon receiving the notification, in step s506, the MS sends to a MS of a second operator a roaming activation request.

When an event (e.g., earthquake, fire) occurs in the area 150, all of the network nodes 102, 104, 106, and 108 may be congested due to unexpected high network traffic. In such case, it might not be desirable to ask the already congested nodes 106 and/or 108 of the MNO2 to serve UEs 122 and 124 that belong to the MNO1. In other words, if the network nodes 106 and/or 108 of the MNO2 are already congested with its own subscribers, it will be damaging and unfair to bombard the network nodes with new call requests coming from subscribers of the MNO1.

Thus, according to some embodiments of this disclosure, a method of activating a temporary roaming further comprises checking congestion levels of the network nodes 102, 104, 106, and 108 serving in the area 150 and determining the activation of the temporary roaming based on the congestion levels of the network nodes.

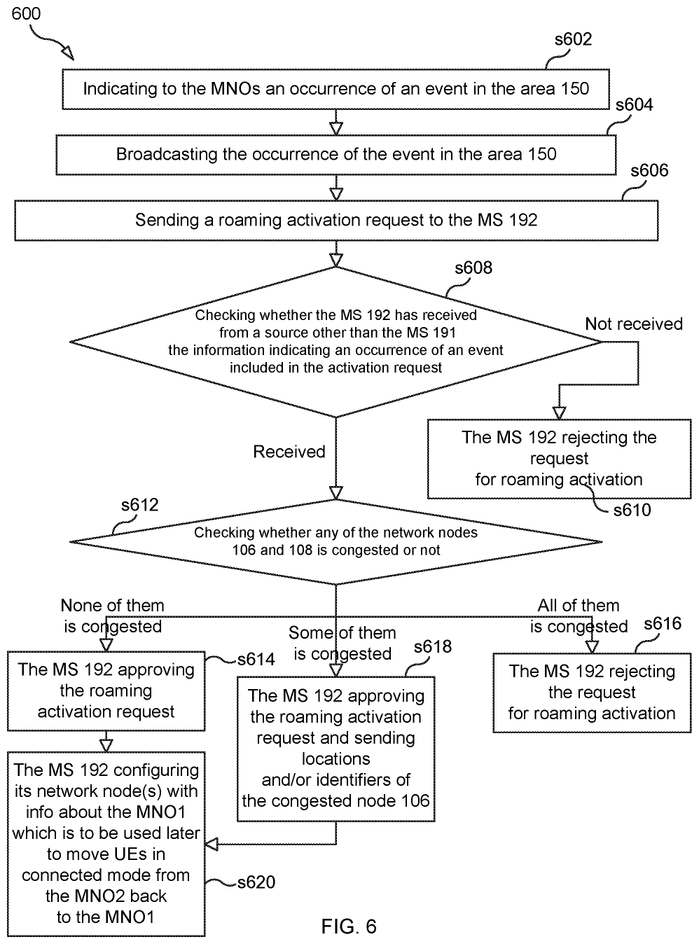

FIG. 6 is a flow chart illustrating a method of triggering a temporary roaming according to some embodiments of this disclosure.

The method may begin with step s602. In the step s602, an authority CBE indicates to the MNO1 and the MNO2 an occurrence of an event (e.g., earthquake, fire) in the area 150. In step s604, based on the indication, the MS 191 of the MNO1 triggers the network nodes 102 and 104 that serve the area 150 to broadcast a message indicating the occurrence of the event.

In step s606, the MS 191 sends to the MS 192 (of the target roaming operator MNO2) a roaming activation request. The roaming activation request may include geographical coordinates of the area 150 and/or the information indicating the occurrence of the event.

After receiving the roaming activation request, in step s608, the MS 192 checks whether it has received the information indicating the occurrence of the event from a source other than the MS 191. This step is similar to the step s206 shown in FIG. 2. Like the step s210, in step s610, if the MS 192 has not received the information indicating the occurrence of the event, the MS 192 rejects the roaming activation request and sends toward the MS 191 a message rejecting the roaming activation request.

If the MS 192 received the information indicating the occurrence of the event, however, in step s612, the MS 192 checks whether any of the network nodes 106 and 108 that belong to the MNO2 is congested. If none of the network nodes 106 and 108 is congested, then, in step s614, the MS 192 approves the request for the roaming activation.

On the other hand, if all of the network nodes 106 and 108 are congested, in step s616, the MS 192 rejects the roaming activation request and sends toward the MS 191 a message rejecting the roaming activation request.

If at least one of the network nodes 106 and 108 is not congested (e.g., the network node 106), in step s618, the MS 192 sends an acknowledgement message approving the roaming activation request with a geographical location covered by the congested network node 106 and/or an identifier identifying the congested network node 106. The identifier may be EARFCN and PCI of the network node 106.

After the MS 191 receives from the MS 192 an acknowledgement message approving the roaming activation request, the MS 191 may trigger the network nodes 102 and/or 104 to broadcast an alarm state message indicating that the roaming has been approved. The MS 191 may further trigger the network nodes 102 and/or 104 to send to the UEs 122 and 124 information identifying the congested network node 106 of the MNO2.

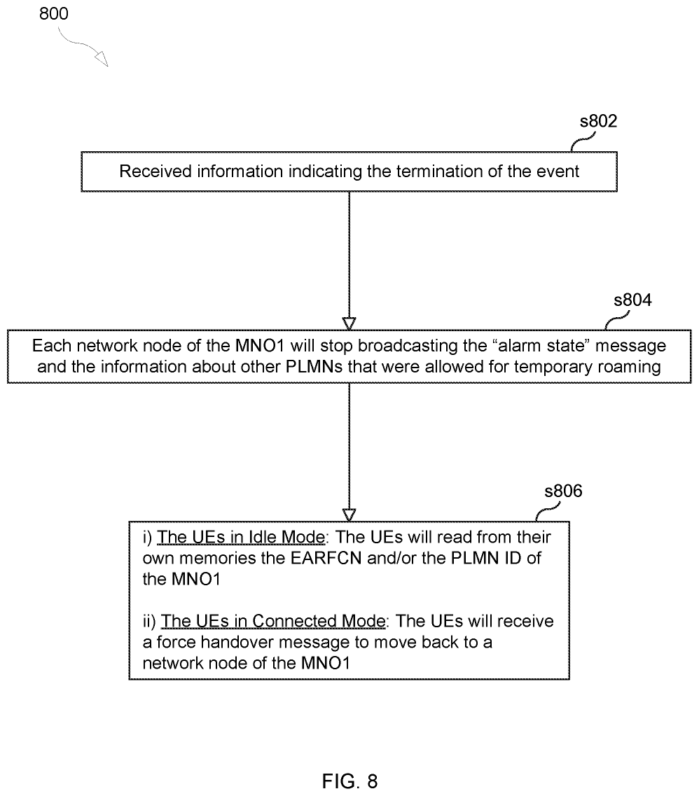

After the MS 192 approves the roaming activation request, in step s620, the MS 192 configures its network node(s) with information about the MNO1 (e.g., EARFCN). The information about the MNO1 may be used in step s806 shown in FIG. 8 such that the UEs that are (i) in connected mode and (2) served by the MNO2 (via roaming) to return to their original MNO (the MNO1) after roaming alarm is ended. In one embodiment, at the end of the roaming alarm, a UE that is a subscriber of MNO1 but that is being served by a network node of MNO2 due to roaming should return to a network node of MNO1 (i.e., disconnect from the network node of MNO2 and connect to a network node of MNO1). In one embodiment, in order for the UE to return to a network node of MNO1 the network node of MNO2 serving the UE has to trigger a handover of the UE to MNO1 from MNO2, and in order for the network node of MNO2 to trigger the handover, the network node needs to have some information about MNO1 (e.g., EARFCN of MNO1).

According to some embodiments, the UEs 122 and/or 124 may determine whether they are out of the coverage of the MNO1's network (e.g., due to an outage—transmission issue in area 1 of the operator).

If the UEs 122 and/or 124 determine that they are not out of the coverage of the MNO1's network, after receiving from the network nodes 102 and/or 104 an alarm state message indicating that the roaming has been approved, the UEs 122 and/or 124 send Attach messages to the network node 108 for establishing an initial connection. The UEs 122 and/or 124 do not send Attach messages to the network node 106 because they received from the network nodes 102 and/or 104 the information indicating that the network node 106 is congested.

If the UEs 122 and/or 124 determine that they are out of the coverage of the MNO1's network (e.g., when the UEs lose RPLMN coverage), the UEs may search for alternative networks. According to some embodiments, the UEs may use a USIM file that list networks that the UEs may consider when the UEs lose the RPLMN coverage. Also they may be allowed to select and connect to the congested network node 106 of the MNO2.

In a summary, the UEs 122 and 124 are allowed to make a call even on the target congested cells (e.g., the network node 106) if the UEs 122 and 124 do not have any radio coverage from the MNO1 and if while reading SIBs of target cell emergency situation, detecting that ETWS has been activated.

According to some embodiments, the MS 191 and the MS 192 may continue to exchange information regarding congested network node(s) belonging to the MNO2. For example, if the congestion of the network node 106 of the MNO2 becomes relieved after the MS 192 sends the information identifying the network node 106 in step s616, the MS 192 may inform the MS 191 that the network node 106 is no longer congested. Then the MS 191 may trigger the network nodes 102 and 104 to update their broadcasted information such that the broadcasted message no longer identifies the network node 106 as being congested such that the UEs 122 and/or 124 may attempt to connect to the network node 106.

The congestion level of a cell may be determined using any one of the three methods below.

First Method (At the network side): A MS of a MNO receives a KPI (Key Performance Indicator) of cell(s) periodically (e.g, every 15 minutes) and based on the received KPI, the MS deduces the overload level of each cell. The first method does not provide real-time information of the congestion level of a cell.

Second Method (At the network side): This is a real time method in which each time a cell (e.g., cell 1) becomes congested, the Radio Node (RN2) controlling a cell 2 sends to the MS associated with the cell 1 a notification notifying that the cell 1 and/or cell 2 is congested.

Third Method (At the UE side): As an indicator of congestion of a cell, a cell preference indicator (CPI) described in U.S. Pat. No. 8,687,486 may be transmitted by a radio base station to all UEs of an operator located in that area. The CPI value may be a binary load indicator value that indicates whether the cell is considered to be loaded or unloaded, or a load indicator value that indicates one of three or more cell load levels. The patent is incorporated by reference in this application.

After the UEs 122 and 124 receive an alarm state message indicating that a temporary roaming is permitted, the UEs may attempt to switch connecting from the original PLMN (e.g., the PLMN of the MNO1) to a target roaming PLMN (e.g., the PLMN of the MNO2).

The target roaming PLMN may be selected from a list of alternative domestic networks. According to some embodiments of this disclosure, the list may be provided to the UEs via (1) NAS signaling (similar to EPLMNs), (2) USIM (similar to EF_{NETPAR}), and (3) RRC (e.g., in broadcasting).

If RRC is used, the RRC may provide to a UE that is in the “alarm state” (e.g., the UE that has received the “alarm state” message from its associated network node) (1) additional network identities (PLMN IDs or similar identifiers) and (2) additional carrier frequencies (EARFCNs or similar) to be considered in cell reselection.

If a PWS is activated in an area before the signaling path to a serving base station (e.g., eNB) serving the area is impaired, a UE may use (a) a PWS message or (b) a new broadcast indicator of “alarm state” to determine whether the alarm state is active.

The signaling path to the serving base station, however, may be impaired before the PWS is activated. If the signaling path becomes impaired (e.g., when a backhaul has failed, but eNB works and has backup power) before the aforementioned PWS message or the broadcast indicator is conveyed to the UE, according to some embodiments, the base station (e.g., eNB) may cease transmission of the message or the indicator after a time-out or send a new indication indicating that the base station is not operational to prevent the UE from wasting time trying to connect to the base station.

The UE associated with the failed eNB may initially perform cell reselection within a neighbor cell list provided via broadcasting. If the UE does not find any cells within a given period, the UE may start searching all frequencies and radio access technologies (RATs) it is capable of handling. The order of the searching may not be specified, so the UE may try to optimize the searching based on other information. If any of the cells of the RPLMN that the UE has found or the listed alternative networks indicates to the UE the “alarm state,” then the UE may consider that the “alarm state” is currently active.

When the “alarm state” is active, the cell reselection and network selection procedures (e.g., specified in 3GPP TS 36.304 and 23.122) may change. In this state the UE may consider all listed alternative networks as potential targets regardless of whether the networks are included in the regular neighbor cell lists and EPLMNs and regardless of the priority order stored on current Elementary Files (EFs) on the USIM. The UE, however, may consider all listed alternative networks as potential targets when the service level in the current RPLMN has dropped below a defined level. This level may be defined via specification, USIM, NAS, or RRC.

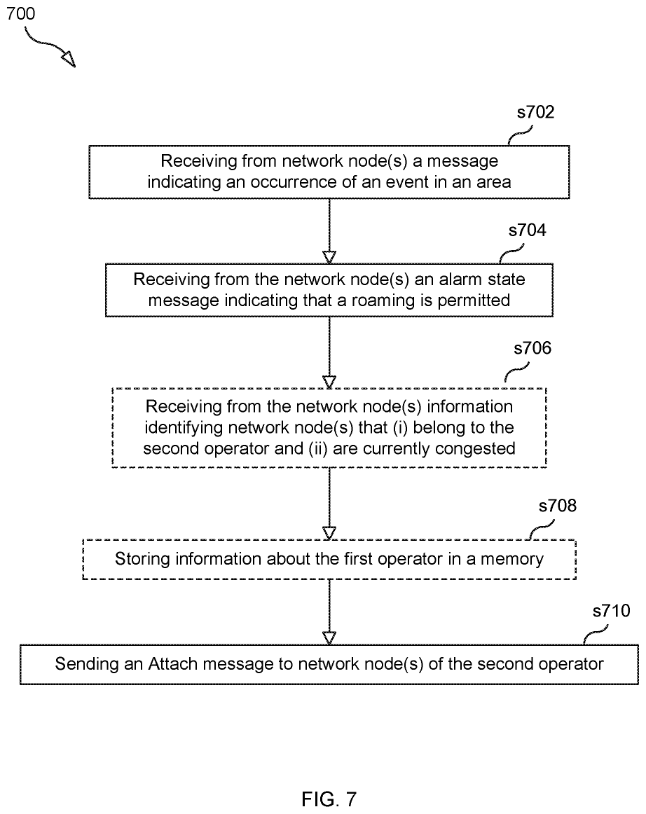

FIG. 7 is a flow chart illustrating a method of triggering the UEs 122 and 124 to change their PLMNs according to some embodiments of this disclosure. The method may begin with step s702.

In the step s702, the UEs 122 and 124 belonging to the MNO1 receive from the network nodes 102 and/or 104 of the MNO1 a message indicating an occurrence of an event in the area 150.

After receiving the message indicating the occurrence of the event, in step s704, the UEs 122 and 124 receive from the nodes 102 and/or 104 an alarm state message indicating that a temporary roaming is permitted. The UEs 122 and 124 may also receive information regarding the MNO2—the potential target of the temporary roaming. The information may be EARFCN of the MNO2 and/or the PLMN ID of the MNO2.

In optional step s706, the UEs 122 and 124 may also receive from the nodes 102 and/or 104 information identifying network node(s) (e.g., PCI) that (i) belong to the MNO2 and (ii) are currently congested. As explained above with respect to the step s618 in FIG. 6, this information is based on the information that the MS 191 received from the MS 192 in response to the MS 191's activation request that was sent to the MS 192.

The messages mentioned in steps s704 and s706 may be received in any order.

After receiving the alarm state message, in optional step s708, the UEs 122 and 124 store the information about the MNO1 (e.g., the EARFCN and the PLMN ID of the MNO1) in their memories such that the UEs can use this information later to return to the network of the MNO1 after the temporary roaming ends. In step s710, the UEs 122 and 124 send Attach messages to the network nodes 106 and/or 108 of the MNO2 for temporary roaming if at least one of the following roaming conditions is satisfied.

(1) The UEs have no non-default bearers and/or no bearers with ongoing data transmission (i.e., when there is a low risk of traffic disturbance).

(2) Reference Signal Received Quality (RSRQ) or Reference Signal Received Power (RSRP) of the network nodes 102 and/or 104 is below a certain threshold.

(3) The broadcasted congestion level of the network nodes 102 and/or 104 is above a certain level.

(4) The call request by the UEs 122 and/or 124 has been rejected by the network nodes 102 and/or 104 beyond a time limit (the call request rejection beyond the time limit indicates that a network is congested).

(5) The UEs 122 and/or 124 cannot make a call on the nodes 102 and/or 104 due to network issues (e.g., network interference or software/hardware issue at a Radio Node side).

By configuring the UEs 122 and/or 124 to attempt to connect to the network node(s) of the MNO2 only when at least one of the roaming conditions is satisfied, potential wasteful toggling between PLMNs may be reduced.

As explained above with respect to the step s616 shown in FIG. 6, when all network nodes of the MNO2 are congested, the MS 192 rejects the MS 191's roaming activation request and thus the UEs 122 and/or 124 would not attempt to connect to the network nodes of the MNO2. Configuring the UEs to attempt to access the network node(s) of the MNO2 only when at least one of the roaming conditions is satisfied is a safeguard when the inter-network coordination between the OSSs fails as a result of the occurrence of the event.

As explained above with respect to the step s618 shown in FIG. 6, the information identifying the congested node (e.g., the network node 108) of the target roaming operator (e.g., the MNO2) that serves the area 105 may be sent to the UEs 122 and 124. In some embodiments, the information is included in SIB5 of a message broadcasted to the UEs 122 and 124. The number of congested network nodes that can be included in the SIB5, however, is limited.

Thus, according to some embodiments of this disclosure, congestion detection is performed at a cell level, not an area level, and a new entity at the MS 192 denoted MS 192__{EARFCN+PCI_filtering} calculates the maximum number of EARFCN+PCI that can be included in the SIB5 and takes necessary filtering actions to determine EARFCNs and PCIs to be included in the SIB5.

In some embodiments, the filtering actions may be based on EARFCN priority. The MS 192__{EARFCN+PCI_filtering} may filter the list of EARFCN+PCI and select/send only the EARFCN+PCI having a higher priority.

For example, if there are three frequencies (three EARFCN) for the network of the target roaming operator (e.g., the MNO2), which correspond to three different network nodes covering the area 150, then only the network node with the highest priority will be allowed to be included in the SIB5 and the remaining two network nodes with lower EARFCN will not be included in the SIB5.

In other embodiments, the filtering actions may be based on cell load. For example, if there are three frequencies (three EARFCN) for the network of the target roaming operator (e.g., the MNO2), which correspond to three different network nodes covering the area 150, then only the network node with the least load will be allowed and the remaining two network nodes with lower EARFCN will be blacklisted.

According to some embodiments of this disclosure, after the event occurred in the area 150 ends, the temporary roaming may become deactivated, and the UEs 122 and 124 go back to the network nodes 102 and 104 of the MNO1.

FIG. 8 is a flow chart illustrating a method of terminating the activated temporary roaming according to some embodiments.

The method may begin with step s802. In the step s802, after the event occurred in the area 150 ends, the MNO1 and the MNO2 are informed (e.g., via CBE-CBC interface(s) or operator staff manual intervention on OSS) of the termination of the event.

After the MNO1 and the MNO2 are informed of the termination of the event, in step s804, the nodes 102 and 104 of the MNO1 stop broadcasting the alarm state message as well as the information identifying the MNO2 (e.g., the PLMN ID and/or the EARFCN of the MNO2).

After the network nodes 102 and 104 stop broadcasting the alarm state message, the UEs 122 and 124 should return to their home network (MNO1). In order to accelerate the return of the UEs 122 and 124 back to their original MNO (the MNO1), in step s806, the UEs in idle mode may read from their own memories the EARFCN and/or the PLMN ID of the MNO1, and perform reselection of cell(s) associated with any network node belonging to the MNO1 (i.e., the nodes 102 and/or 104). On the other hand, in some embodiments, for the UEs in connected mode (e.g., the UEs connected to the network nodes 106 and/or 108 via roaming at the time the broadcasting of the alarm state message was stopped), the network nodes 106 and/or 108 of the MNO2 may trigger the UEs to move to a network node (e.g., the network node 102 and/or 104) belonging to the MNO1. In other words, the network nodes 106 and/or 108 may trigger a handover of the UEs from their network to the network of the UEs' home MNO. This is because, in some embodiments, the UEs in the connected mode cannot move to other network by their own actions. Thus, contrary to a UE in the idle mode, a network node (e.g., node 106) triggers the move of a UE in connected mode from a cell in MNO2 (e.g., a cell served by node 106) to a cell in MNO1 (e.g., a cell served by node 102).

After the roaming ends, the UEs may switch back to the same cell (e.g., a cell served by network node 102) to which they were connected before the roaming started or to another cell (e.g., a cell served by network node 104) belonging to the UEs' home MNO (e.g., the MNO1). That is, if due to roaming initiation, UE1 has moved from a cell of network node 102 of MNO1 to a cell of network node 106 of MNO2, then at the end of roaming alarm, it is not necessary that UE1 will return to the same cell of MNO1, but it could return to any other cell of MNO1. This is because between the time at which the roaming alert was activated and the time which the roaming alert was terminated, the UE could have moved from one edge of a cell of the MNO2, which is closer to the network node 102 than the network node 104, toward the opposite edge of the same cell, which is closer to the network node 104 than the network node 102.

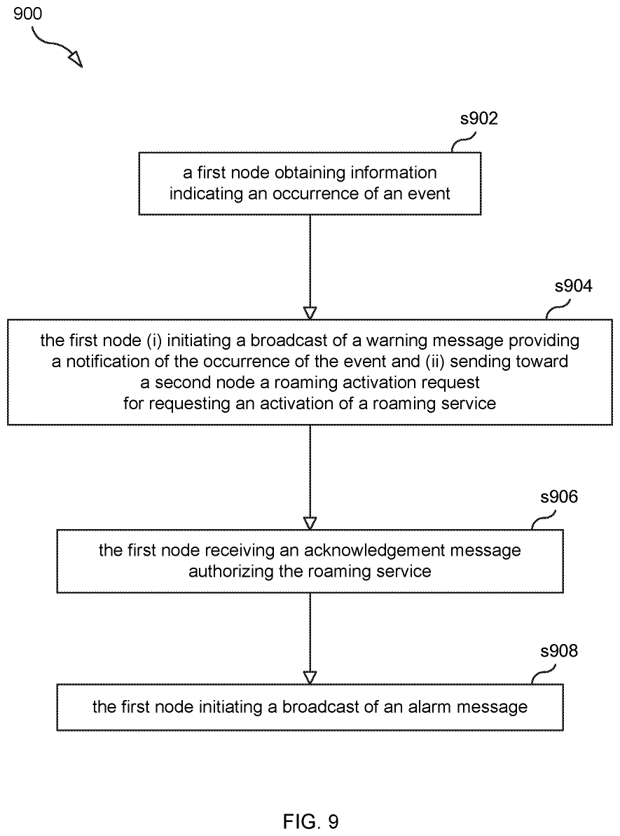

FIG. 9 is a flow chart illustrating a process 900 according to some embodiments. Process 900 may begin in step s902.

Step s902 comprises a first node obtaining information indicating an occurrence of an event. The first node may belong to a first public land mobile network (PLMN).

Step s904 comprises after obtaining the information, the first node (i) initiating a broadcast of a warning message providing a notification of the occurrence of the event and (ii) sending toward a second node belonging to a second PLMN a roaming activation request for requesting an activation of a roaming service. The second PLMN may be different from the first PLMN.

Step s906 comprises after sending the roaming activation request, the first node receiving an acknowledgement message authorizing the roaming service. The acknowledgement message may be sent by the second node.

Step s908 comprises as a result of receiving the acknowledgement message authenticating the roaming service, the first node initiating a broadcast of an alarm message. The alarm message may indicate the authorization of the roaming service.

In some embodiments, process 900 further includes the first node determining whether at least a predetermined number of network nodes (i) that are located within a particular area and (ii) that belong to the first PLMN are congested or not. The roaming activation request may be sent toward the second node at least based on the determination of whether at least the predetermined number of network nodes is congested.

In some embodiments, the received acknowledgement message comprises an identifier identifying a congested network node (i) that is located within a particular area and (ii) that belongs to the second PLMN.

In some embodiments, process 900 further includes the first node sending toward at least one network node belonging to the first PLMN a message triggering said at least one network node to broadcast information identifying said congested network node belonging to the second PLMN.

In some embodiments, process 900 further includes receiving a message indicating that the congested network node belonging to the second PLMN is no longer congested and as a result of receiving the message, sending toward said at least one network node belonging to the first PLMN a message triggering said at least network node to stop broadcasting the information identifying said congested network node belonging to the second PLMN. The message may be sent by the second node.

In some embodiments, process 900 further includes the first node obtaining information indicating that the event has ended and as a result of obtaining the information indicating that the event has ended, the first node stopping the broadcast of the alarm message.

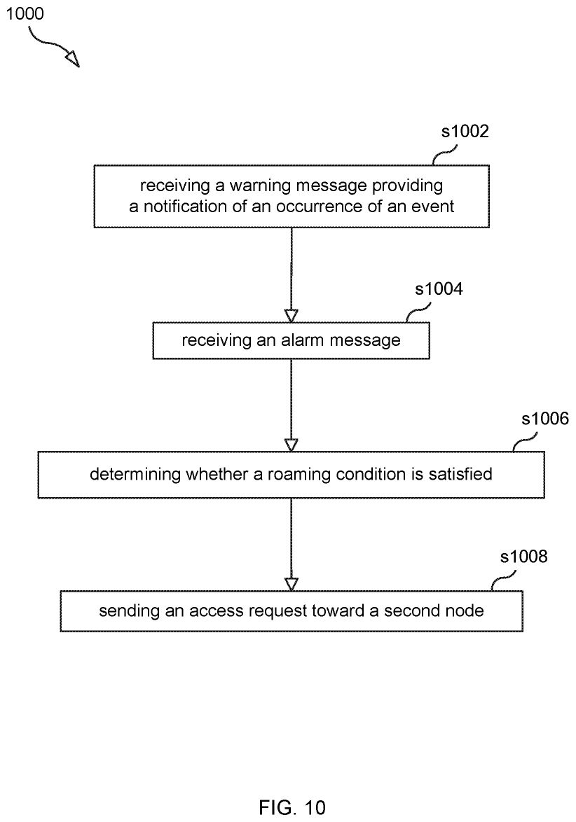

FIG. 10 is a flow chart illustrating a process 1000 according to some embodiments. Process 1000 may begin in step s1002.

Step s1002 comprises receiving a warning message providing a notification of an occurrence of an event. The warning message may be broadcasted by a first node belonging to a first public land mobile network (PLMN).

Step s1004 comprises receiving an alarm message. The alarm message may indicate that a user equipment (UE) is authorized to connect to a node belonging to a PLMN that is different from the first PLMN provided that a roaming condition is satisfied.

Step s1006 comprises determining whether the roaming condition is satisfied.

Step s1008 comprises after receiving the alarm message and after determining that the roaming condition is satisfied, sending an access request toward a second node belonging to a second PLMN that is different from the first PLMN.

In some embodiments, process 1000 further includes receiving broadcasted information identifying a congested network node belonging to the second PLMN.

In some embodiments, process 1000 further includes receiving broadcasted information identifying a PLMN that is available for roaming and/or at least one carrier frequency corresponding to the PLMN that is available for roaming.

In some embodiments, process 1000 further includes storing in a memory included in the UE an identifier identifying the first PLMN and/or at least one carrier frequency corresponding to the first PLMN.

In some embodiments, process 1000 further includes detecting that receiving the alarm message has been stopped, as a result of the detection, loading from the memory the identifier identifying the first PLMN and/or said at least one carrier frequency corresponding to the first PLMN, and using at least one of the identifier identifying the first PLMN and said at least one carrier frequency corresponding to the first PLMN to establish a connection.

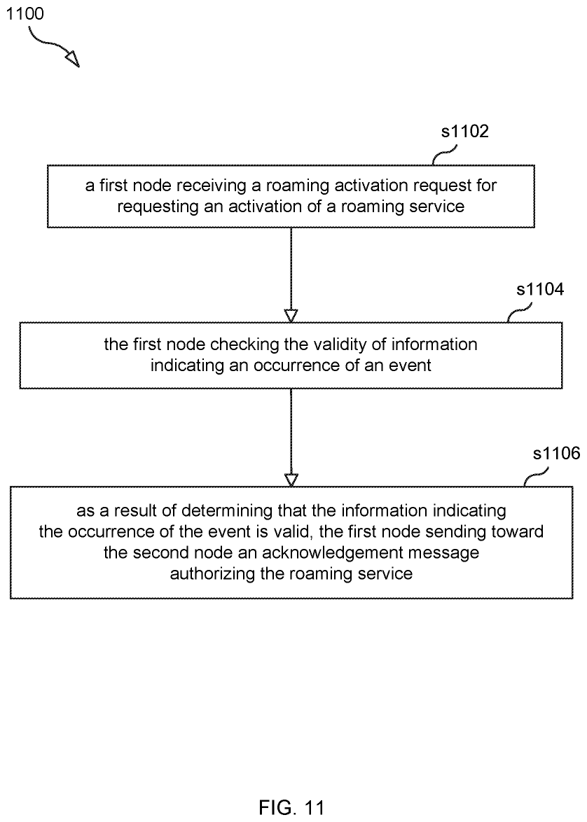

FIG. 11 is a flow chart illustrating a process 1100 according to some embodiments. Process 1100 may begin in step s1102.

Step s1102 comprises a first node receiving a roaming activation request for requesting an activation of a roaming service. The roaming activation request may be sent by a second node and the roaming activation request may include information indicating an occurrence of an event.

Step s1104 comprises after receiving the roaming activation request, the first node checking the validity of the information indicating the occurrence of the event.

Step s1106 comprises as a result of determining that the information indicating the occurrence of the event is valid, the first node sending toward the second node an acknowledgement message authorizing the roaming service.

The first node may belong to a first public land mobile network (PLMN) and the second node may belong to a second PLMN that is different from the first PLMN.

In some embodiments, checking the validity of the information indicating the occurrence of the event comprises determining whether the first node obtains information indicating the occurrence of the event before the first node receives the roaming activation request and after the determination, comparing the information included in the roaming activation request with the obtained information indicating the occurrence of the event.

In some embodiments, process 1100 further includes the first node checking whether any network node belonging to the first node located within a particular area is congested or not and as a result of determining that at least one network node belonging to the first node located within the particular area is congested, including in the acknowledgement message an identifier identifying said at least one network node.

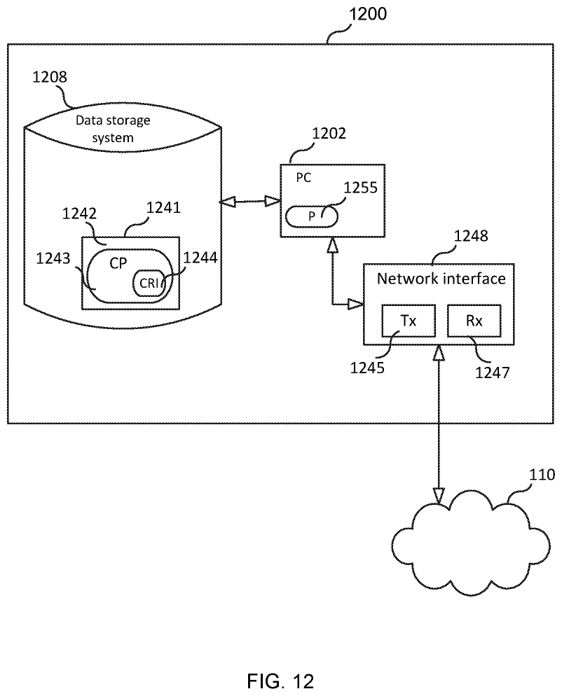

FIG. 12 is a block diagram of an apparatus 1200, according to some embodiments, for implementing the MS 191 or the MS 192. As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); a network interface 1248 comprising a transmitter (Tx) 1245 and a receiver (Rx) 1247 for enabling apparatus 1200 to transmit data to and receive data from other nodes connected to a network 110 (e.g., an Internet Protocol (IP) network) to which network interface 1248 is connected (directly or indirectly) (e.g., network interface 1248 may be wirelessly connected to the network 110, in which case network interface 1248 is connected to an antenna arrangement); and a local storage unit (a.k.a., “data storage system”) 1208, which may include one or more non-volatile storage devices and/or one or more volatile storage devices. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

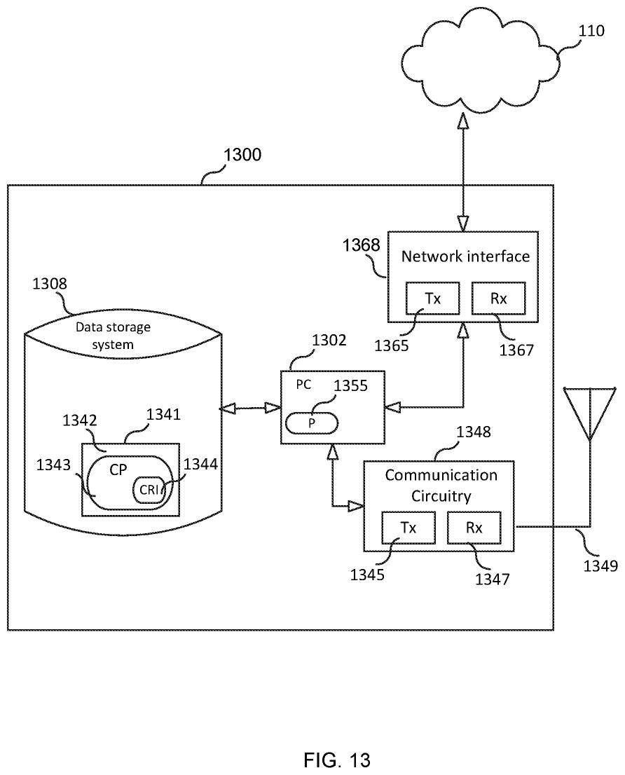

FIG. 13 is a block diagram of an apparatus 1300, according to some embodiments. The apparatus 1300 may be used to implement any one of the network nodes 102, 104, 106, and 108. As shown in FIG. 13, the network node may comprise: processing circuitry (PC) 1302, which may include one or more processors (P) 1355 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 1300 may be a distributed computing apparatus); a network interface 1368 comprising a transmitter (Tx) 1365 and a receiver (Rx) 1367 for enabling apparatus 1300 to transmit data to and receive data from other nodes connected to a network 110 (e.g., an Internet Protocol (IP) network) to which network interface 1348 is connected; communication circuitry 1348, which is coupled to an antenna arrangement 1349 comprising one or more antennas and which comprises a transmitter (Tx) 1345 and a receiver (Rx) 1347 for enabling the network node to transmit data and receive data (e.g., wirelessly transmit/receive data); and a local storage unit (a.k.a., “data storage system”) 1308, which may include one or more non-volatile storage devices and/or one or more volatile storage devices. In embodiments where PC 1302 includes a programmable processor, a computer program product (CPP) 1341 may be provided. CPP 1341 includes a computer readable medium (CRM) 1342 storing a computer program (CP) 1343 comprising computer readable instructions (CRI) 1344. CRM 1342 may be a non-transitory computer readable medium, such as, magnetic media (e.g., a hard disk), optical media, memory devices (e.g., random access memory, flash memory), and the like. In some embodiments, the CRI 1344 of computer program 1343 is configured such that when executed by PC 1302, the CRI causes the network node to perform steps described herein (e.g., steps described herein with reference to the flow charts). In other embodiments, the network node may be configured to perform steps described herein without the need for code. That is, for example, PC 1302 may consist merely of one or more ASICs. Hence, the features of the embodiments described herein may be implemented in hardware and/or software.

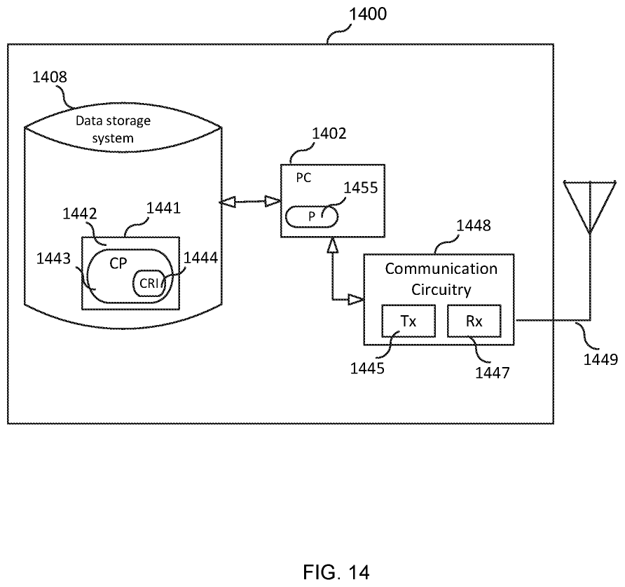

FIG. 14 is a block diagram of a UE 1400, according to some embodiments. Any one of the UEs 122, 124, 132, 134, and 136 may be implemented using the UE 1400. As shown in FIG. 14, UE 102 may comprise: processing circuitry (PC) 1402, which may include one or more processors (P) 1455 (e.g., one or more general purpose microprocessors and/or one or more other processors, such as an application specific integrated circuit (ASIC), field-programmable gate arrays (FPGAs), and the like); communication circuitry 1448, which is coupled to an antenna arrangement 1449 comprising one or more antennas and which comprises a transmitter (Tx) 1445 and a receiver (Rx) 1447 for enabling UE 102 to transmit data and receive data (e.g., wirelessly transmit/receive data); and a local storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes UE 102 to perform steps described herein (e.g., steps described herein with reference to the flow charts). In other embodiments, UE 102 may be configured to perform steps described herein without the need for code. That is, for example, PC 1402 may consist merely of one or more ASICs. Hence, the features of the embodiments described herein may be implemented in hardware and/or software.

According to some embodiments of this disclosure, there are different ways of making the UEs 122 and/or 124 to switch connecting between different networks.

Sending a Detach Command—A UE may be forced to switch to another network by sending to the UE a Detach command indicating “re-attach not required” and the Evolved Packet System (EPS) Mobility Management (EMM) may cause IE set to #11 (as an example) (PLMN not allowed). See 3GPP TS 24.301 clause 5.5.2.3.2. Due to the 3GPP TS 23.122 clause 3.1, however, the Home Public Land Mobile Network (HPLMN) (if the EHPLMN (Equivalent HPLMN) list is not present or is empty) or an EHPLMN (if the EHPLMN list is present) may not be stored in the list of “forbidden PLMNs.” Thus, this method may not work for UEs when RPLMN=HPLMN.

Configuring alternative networks as EPLMNs—This method may make a UE to select the alternative PLMN faster than what happens at regular roaming (e.g., from RPLMN to a non-RPLMN/EPLMN (Equivalent PLMN)).

Case (a)—Some EARFCN of the alternative PLMN is listed in the Neighbor Cell List (NCL).

Case (b)—None of them is listed.

Note that RRC (Radio Resource Control) info typically does not include PLMN info, but that is provided by NAS (Non-Access Stratum) signaling.

In case of the scenario (a), the regular search procedure of cell reselection (as described in e.g. 3GPP TS 36.304 and 36.133) will quickly (e.g., within a few seconds) find the alternative PLMN if the RPLMN fails. The UE may be allowed to measure outside the NCL, but that is in practice unlikely since it will either lead to not fulfilling 36.133 performance or added battery consumption or both.

In case of the scenario (b), the UE will, when no RPLMN/EPLMN cell is found within the neighbor cell list, expand the scan to the entire set of frequencies and RATs (see e.g. 23.122 clause 4.4.3.1). If the UE then finds a cell of its RPLMN/EPLMN, it can stop the searching (e.g., when the found cell is considered the top priority network according to 23.122).

Both methods mentioned above are faster than the average roaming search procedure. In the average roaming search procedure, the alternative PLMN isn't RPLMN or HPLMN (the highest prio network types), so the UE must complete the entire search before concluding what the available top-priority network is.

The UE may get EPLMN lists as part of Location Update and/or Attach procedures. Location Updates are mostly periodic (T3402) with periodicities defined by the network ranging up to 30 minutes (or turned off). Potential network side triggers to execute the update at a more precise point in time are: release of the RRC connection with a cause ‘Load Balancing TAU Required’ (need to page and establish RRC connection first for Idle UEs) and UE-specific DRX cycle is updated <seems to be possible only via Attach/TA (Tracking Area) Update, i.e. doesn't speed up procedure and thus no potential trigger/improvement>.

In order to handle the situation of RPLMN failure as part of the disaster, the EPLMN configuration must happen in advance. However, that means the UE will consider alternative PLMNs as EPLMNs even prior to dynamic roaming being activated. In case (a) the risk is extremely high. In case (b) the risk is low but may still be unacceptable in areas with marginal coverage. If the UE does reselect prior to roaming activation, the result depends on the rejection cause value on the target side. The UE will see a new PLMN ID (identity) and will thus always initiate Tracking Area Update or Attach procedures. The incoming roaming UE includes it's GUTI (Globally Unique Temporary Identifier) in the TA/Attach Request. The GUMMEI (Globally Unique Mobility Management Entity Identifier) part of the GUTI will show that the UE comes from another PLMN. The network will not recognize this GUTI and will probably request the UE to identify itself, i.e. send it's IMSI (International Mobile Subscriber Identity). At this point it is clear that the UE is an incoming roamer with a specific HPLMN (may be the same as that of the previous network where the GUTI was assigned, but not necessary), but temporary roaming has not been activated for this HPLMN at this point in time. Normally, the UE is rejected with a cause value such as “PLMN no allowed” (#11). The UE will then refrain from further automatic attempts to connect for a time set by T3245, ranging between 24 and 48 hours. If a “softer” rejection cause would be used, say “Roaming not allowed in this Tracking Area” (#13), then the UE will only regard this TAC as forbidden, for a period between 30 and 60 minutes. This will delay roaming activation, when it finally happens, and meanwhile increase the signaling load.

Configuring alternative networks as EHPLMN—In common cases this technique may reduce the search time in “Automatic PLMN Search”, which almost all users have activated. However, in common cases, it is almost certain that listed EHPLMN will not have higher priority than the HPLMN, so the search time reduction will probably not happen. Hence the EPLMN list may not be useful for the case of dynamic roaming activation. However, 23.122 clause 4.4.5.1 presents a selectable exception:

As an alternative option to this, if the MS is in automatic network selection mode and it finds coverage of an EHPLMN, the MS may register to that EHPLMN and not return to the registered PLMN or equivalent PLMN. If the EHPLMN list is not present or is empty, and the HPLMN is available, the MS may register on the HPLMN and not return to the registered PLMN or equivalent PLMN. The operator shall be able to control by SIM (Subscriber Identity Module) configuration whether an MS (Mobile Station) that supports this option is permitted to perform this alternative behavior.

This choice seems to be controlled via 31.102 EF_{LRPLMNSI}. The EF_{NASCONFIG} can also configure some detailed behavior, e.g. fast search for higher prio network. The exception above says “an EHPLMN”, suggesting that the UE may stop searching upon detecting any EHPLMN and need not search for the highest prio EHPLMN (basic rule in 23.122 clause 4.4.3.1.1).

If the HPLMN had time to load a new EFEHPLMN and related EFs (Elementary Files) in the UE prior to the disaster and the point when roaming is needed, then the UE scanning stops at any of the listed “roaming partners”. This refined EHPLMN method may be useful, but is only applicable for UEs having a domestic PLMN where the disaster happens. It is unwanted to list roaming partner networks long before the activation of roaming, similar to what is described for “Configuring alternative networks as EPLMNs” above, since that will degrade the UE network selection in normal operation.

Active mode steering—In the method described above, it is assumed that that there is no GWCN configuration (e.g. S10 between MMES (Mobility Management Entity)) between roaming partner networks. That is normally quite unwanted by independent operators due to tight interwork and leakage of proprietary information. This assumption rules out Handover, whether it is the backward or forward type. Hence a network-ordered mobility is limited to (some variant of) Release with redirection (RwR). Two categories are: 1. Existing RwR (e.g., the type specified in 36.331) and 2. Some updated variant of RwR.

For case 1, the target PLMN(s) must be defined as EPLMN, else the UE will not consider the cells as valid targets (36.304 clauses 5.2.7 and 4.3). Hence similar issues as described in “Configuring alternative networks as EPLMNs” occur. The UE will expect to be registered on the target side and perform a Tracking area update. The target PLMN shall, based on GUTI, reject the UE with a “benign” cause value #9 (see 24.301 clause 5.5.3.2.5: “If the rejected request was not for initiating a PDN connection for emergency bearer services, the UE shall subsequently, automatically initiate the attach procedure”). This is at least a special configuration and may also require non-standard functionality to apply this behavior only to UEs with particular GUTI values.

For case 2, one idea is that the current RPLMN can use a new variant of “Release with Redirect”, which tells the UE to reselect to another (one or more) PLMN (new IE). In this RwR mode the UE understands, if the indicated PLMN ID is not defined as a currently defined EPLMN, that the UE shall assume it is “unknown” in the target network and shall thus start with Attach instead of Location Update. The main drawback is that the steering doesn't work if the disaster “kills” the source side backhaul or eNB before there been time to order selected fraction of UEs to other networks (probably after having activated the temporary roaming). New steering functionality must also be implemented in all co-operating networks.

Embedded dual SIM—The UE would have “alternative USIM blobs” inside the regular USIM. The alternative blobs are activated when disaster state is detected. The word “active” may mean simultaneously used or a sequential activation, triggered by some events. However, this is not the existing way single or dual SIM UEs or specifications work today. Single-SIM UEs do not contain or activate “alternative blobs”. Dual SIM UEs stay attached to multiple networks simultaneously. Nevertheless, an evolved dual SIM UE could be useful.

Dual SIM—See above “Embedded dual SIM” regarding (evolved) regular UICCs. For the case of embedded SIM (also called eSIM or eUICC) in the Consumer variant, an adapted and configured LPA can be notified by the UE when disaster state is present and the LPA (Local Profile Assistant) can then select/swap the active ISD-P (Issuer Security Domain Profile) (essentially equal to USIM/ISIM content), configure relevant EFs etc. This could achieve a fast change of networks. The potential drawbacks are:

1. Each network must provision their ISD-P in all UEs;

2. This is only realistic for domestic roamers;

3. The GSMA eUICC infrastructure must be deployed;

4. A special LPA with remote configurability must be developed (and possibly specified/agreed); and

5. This is thus a quite complex solution.

Dual SIM with evolved 5G tunneling—In this case UEs must have multiple USIMs. A UE can, while connected to one network/PLMN access other networks via tunnels across Internet to the HPLMNs of each USIM. See for example, 3GPP TS 23.501 and FIG. 4.2.8.2.5-2.

The word “evolved” suggests that also 3GPP access can use the NWu/Y2/N1 tunneling. The UE can establish as many tunnels as there are USIMs. In such a case each HPLMN can provide the UE with information about frequencies to scan in the current location and overload indications. The UE can also be “semi-attached” via the tunnels, so that a “light-weight” procedure such as “resume” can suffice to move the tunneled connection to a direct connection. Services could also be supported via the tunnel.′

Such procedures could make network switching quite fast with virtually no co-operation between the networks (incl inter-network OSS interfaces). However, this may require considerable 3GPP standardization.

While various embodiments of the present disclosure are described herein, it should be understood that they have been presented by way of example only, and not limitation. Thus, the breadth and scope of the present disclosure should not be limited by any of the above-described exemplary embodiments. Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. That is, the steps of any methods disclosed herein do not have to be performed in the exact order disclosed, unless a step is explicitly described as following or preceding another step and/or where it is implicit that a step must follow or precede another step.

1. A method, performed by a first node belonging to a first public land mobile network (PLMN), for triggering a temporary roaming, the method comprising:
obtaining information indicating an occurrence of an event;
after obtaining the information,
(i) initiating a broadcast of a warning message providing a notification of the occurrence of the event, and
(ii) sending toward a second node belonging to a second PLMN a roaming activation request for requesting an activation of a roaming service, wherein the roaming activation request includes information indicating the occurrence of the event and further wherein the second PLMN is different from the first PLMN;
after sending the roaming activation request receiving an acknowledgement message authorizing the roaming service, wherein the acknowledgement message was sent by the second node; and
as a result of receiving the acknowledgement message authorizing the roaming service, initiating a broadcast of an alarm message, wherein the alarm message indicates the authorization of the roaming service.

2. The method of claim 1, further comprising:
the first node determining whether at least a predetermined number of network nodes that (i) are located within a particular area and (ii) belong to the first PLMN are congested, wherein the roaming activation request is sent toward the second node at least based on the determination of whether at least the predetermined number of network nodes is congested.

3. The method of claim 1, further comprising:
the first node determining that at least a predetermined number of network nodes that:
(i) are located within a particular area and
(ii) that belong to the first PLMN are congested, wherein
the roaming activation request is sent from the first node toward the second node as a result of:
(i) obtaining the information indicating the occurrence of the event, and
(ii) determining that at least the predetermined number of the network nodes are congested.

4. The method of claim 1, wherein the received acknowledgement message comprises an identifier identifying a congested network node that:
(i) is located within a particular area, and
(ii) belongs to the second PLMN.

5. The method of claim 4, further comprising:
sending toward at least one network node belonging to the first PLMN a message triggering said at least one network node to broadcast information identifying said congested network node belonging to the second PLMN.

6. The method of claim 5, further comprising:
receiving a message indicating that the congested network node belonging to the second PLMN is no longer congested, wherein the message was sent by the second node, and
as a result of receiving the message, sending toward said at least one network node belonging to the first PLMN a message triggering said at least network node to stop broadcasting the information identifying said congested network node belonging to the second PLMN.

7. (canceled)

8. A method performed by a user equipment (UE), the method comprising:
receiving a warning message providing a notification of an occurrence of an event, wherein the warning message was broadcasted by a first network node belonging to a first public land mobile network (PLMN);
receiving an alarm message, wherein the alarm message indicates that the UE is authorized to connect to a second network node belonging to a second PLMN that is different from the first PLMN provided that a roaming condition is satisfied;
determining whether the roaming condition is satisfied; and
after receiving the alarm message and after determining that the roaming condition is satisfied, sending an access request toward the second network node.

9. The method of claim 8, wherein the roaming condition comprises any one or combination of the following:
the UE has no non-default bearer,
the UE has no bearer with ongoing data transmission with the UE,
reference signal received quality (RSRQ) or reference signal received power (RSRP) of the first network node is below a signal threshold,
congestion level of the first network node is above a congestion threshold,
a call request by the UE has been rejected by the first network node beyond a time limit, or
the UE has failed to make a call through the first network node.

10. The method of claim 8, further comprising:
receiving broadcasted information identifying a congested network node belonging to the second PLMN.

11. The method of claim 8, further comprising:
receiving broadcasted information identifying a PLMN that is available for roaming and/or at least one carrier frequency corresponding to the PLMN that is available for roaming.

12. The method of claim 8, further comprising:
storing in a memory included in the UE an identifier identifying the first PLMN and/or at least one carrier frequency corresponding to the first PLMN.

13. (canceled)

14. A method performed by a second node belonging to a second public land mobile network (PLMN) for triggering a temporary roaming, the method comprising:
receiving a roaming activation request for requesting an activation of a roaming service, wherein the roaming activation request was sent by a first node and the roaming activation request includes information indicating an occurrence of an event, wherein the first node belongs to a first PLMN that is different from the second PLMN;
after receiving the roaming activation request, checking the validity of the information indicating the occurrence of the event; and
as a result of determining that the information indicating the occurrence of the event is valid, sending toward the first node an acknowledgement message authorizing the roaming service.

15. The method of claim 14, wherein checking the validity of the information indicating the occurrence of the event comprises:
determining whether the second node obtains information indicating the occurrence of the event before the second node receives the roaming activation request; and
after the determination, comparing the information included in the roaming activation request with the obtained information indicating the occurrence of the event.

16. The method of claim 14, further comprising:
checking whether any network node belonging to the second PLMN located within a particular area is congested or not; and
as a result of determining that at least one network node belonging to the second PLMN located within the particular area is congested, including in the acknowledgement message an identifier identifying said at least one network node.

17. A method performed by a user equipment (UE), the method comprising:
determining that the UE is unable to connect to a first public land mobile network, PLMN, wherein the first PLMN is the UE's home PLMN;
receiving a warning message providing a notification of an occurrence of an event, wherein the warning message was broadcasted by the first PLMN; and
as a result of determining (i) that the UE is unable to connect to the first PLMN and (ii) that the UE has received the warning message providing the notification of the occurrence of the event, sending an access request for accessing a second PLMN that is different from the first PLMN.

18. (canceled)
